(19) United States
(12) Patent Application Publication
(10) Pub. No.: US 2025/0266680 A1
(43) Pub. Date: Aug. 21, 2025

(54) DYNAMIC POWER MANAGEMENT FOR MANAGING CUSTOMER INCENTIVES FOR VIRTUAL POWER PLANT PARTICIPATION

(71) Applicant: Ford Global Technologies, LLC, Dearborn, MI (US)

(72) Inventors: Ryan O'Gorman, Beverly Hills, MI (US); Stuart C. Salter, White Lake, MI (US); Pietro Buttolo, Dearborn Heights, MI (US); Peter Phung, Windsor (CA); Brendan F. Diamond, Grosse Pointe, MI (US)

(21) Appl. No.: 18/444,402

(22) Filed: Feb. 16, 2024

(51) Int. Cl. H02J 3/00; H02J 3/38; H02J 13/00

(52) U.S. Cl. CPC H02J 3/003; H02J 3/381; H02J 13/00004; H02J 2310/58

(57) ABSTRACT

This disclosure includes systems and method to manage customer incentivization and participation in virtual power plant (“VPP”) opportunities. A customer may enroll energy assets into VPP and may receive requests to participate in VPP opportunities as a grid has an impending demand for power greater than the supply of the grid. By participating, a user may earn rewards. By committing energy assets and not participating, or by not responding to requests for enrolled energy assets to participate in VPP, a user may receive a penalty. Participation in VPP may be requested on a grouped basis where some groups may have greater rewards and greater penalties but require more reliable participation from a user. Users may be automatically reassigned between groups based on a reliability metric.

### TECHNICAL FIELD

This disclosure relates to charging and discharging vehicles.

### BACKGROUND

Energy assets including electric vehicles (“EVs”) may include energy storage devices with storage capacities capable of supporting a grid at times where the power demanded from the grid may exceed the grid's supply. Incorporating energy assets including EVs into a grid may be called a virtual power plant (“VPP”).

### SUMMARY

A dynamic power management system may comprise a processor programmed to, responsive to immediate demand to support a grid, send requests to a first grid-support group to connect to the grid within a first duration of time such that at least some vehicles associated with the first grid-support group connect to the grid within the first duration of time; responsive to deferred demand to support the grid, send requests to a second grid-support group to connect to the grid within a second duration of time longer than the first duration of time such that at least some vehicles associated with the second grid-support group connect to the grid within the second duration of time; and responsive to a default-on-commitment parameter of a user, representing an index at which the user is committed to connect a vehicle to the grid and subsequently defaults on that commitment, crossing a predefined threshold, reassign the user from the first grid-support group to the second grid-support group such that the user receives the requests to the second grid-support group but not the requests to the first grid-support group.

A method for dynamic power management may comprise responsive to immediate demand to support the grid, sending requests to a first grid-support group to connect to the grid within a first duration of time such that at least some vehicles associated with the first grid-support group connect to the grid within the first duration of time; responsive to deferred demand to support the grid, sending requests to a second grid-support group to connect to the grid within a second duration of time longer than the first duration of time such that at least some vehicles associated with the second grid-support group connect to the grid within the second duration of time; and responsive to a default-on-commitment parameter of the user, representing an index at which the user is committed to connect a vehicle to the grid and subsequently defaults on that commitment, crossing a predefined threshold, reassigning the user from the first grid-support group to the second grid-support group such that the user receives the requests to the second grid-support group but not the requests to the first grid-support group.

A dynamic power management system may comprise a processor programmed to, responsive to immediate demand to support a grid, send requests to a first grid-support group to connect to the grid within a first duration of time such that at least some vehicles of the first grid-support group connect to the grid within the first duration of time and credit rewards to the at least some vehicles of the first grid-support group; and responsive to deferred demand to support the grid, send requests to both the first grid-support group and a second grid-support group to connect to the grid within a second duration of time longer than the first duration of time such that at least some vehicles of the first grid-support group or the second grid-support group connect to the grid within the second duration of time and credit rewards to the at least some vehicles of the first grid-support group or the second grid-support group.

### BRIEF DESCRIPTION OF THE DRAWINGS

FIG. 1 is a flowchart of an example of VPP implementation.

FIG. 2 is a flowchart of an example of sending selective requests based on a user's membership in a grid-support group.

FIG. 3 is a flowchart of an example of reassigning a user between grid-support groups.

FIG. 4 is a block diagram of an example customer incentivization and management algorithm for VPP.

FIG. 5 is a block diagram of an example customer incentivization and management algorithm for VPP.

FIG. 6 is a block diagram of an example customer incentivization and management algorithm for VPP.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

VPP may describe technologies to aggregate energy assets to support a grid when the power demanded from a grid exceeds the grid's supply. Example energy assets may include home batteries, home energy producers (e.g., residential solar), and electric vehicles (“EVs”). Some VPP technologies may incorporate energy assets like home appliances (e.g., HVAC system, water heater) to reduce an asset's consumption. Compared to many energy assets, EVs may contain an amount of accessible energy that may make EVs especially useful to incorporate into VPPs. Some estimates suggest EVs may provide 7-20 kWh to VPP whereas residential solar and home batteries may only provide around 5-10 kWh.

Although VPP may help support a grid, participation in VPP utilizes a customer's energy assets in ways that may not align with the customer's goals for the asset. For example, VPP participation may turn a customer's heating appliance to a lower temperature than the customer would prefer. In another example, VPP participation may require a customer's EV be plugged into the grid while the customer would rather be driving their EV. Thus, providing an apparatus and method to manage customers' degree of commitment to VPP initiatives may help promote customers' engagement with VPP and thereby make VPP more reliably able to meet a demand of a grid.

Although EVs may be a useful energy asset for VPPs, from a customer's point of view, an EV may be primarily a personal transportation utility. Further, an EVs inclusion in VPP may increase wear-and-tear on the EV. Accordingly, customers may be resistant or even averse to VPP participation. To help customers balance their transportation needs with the opportunity to participate in an aggregate opportunity, management and incentivization methods and apparatuses may increase uptake and the reliability of an aggregate to meet a grid's demands.

Other technologies for managing an ability for a grid to meet demand may include scheduling and behavioral predictive algorithms. Such technologies may manage energy assets but not balance the changing needs and behaviors of customers. Therefore, methods and apparatuses that offset those changing needs with controls and incentives may increase uptake and the reliability of an aggregate to meet a grid's demands.

Customer incentivization may begin when customers self-assign into a grid-support group based on their intended degree of participation and an uncertainty-reward profile of the grid-support group. In some embodiments, customers self-assignment occurs by answering questions that define their anticipated schedule or anticipated goals for rewards or power provided to the grid after which the customer is placed in a grid-support group with customers that may have answered similarly.

Generally, methods and apparatuses may include any number of grid-support groups. Groups may tend to pair higher uncertainty with greater reward, and the highest-uncertainty-and-highest-reward group may be expected to contain fewer customers than lower uncertainty groups. A customer's “uncertainty” may describe the potential consequences a customer faces for not participating in a VPP opportunity.

For example, users in the highest-uncertainty-and-highest-reward group may be notified that connecting to a grid within the time allotted would earn the user 1000*X points but not connecting to the grid within the time allotted twice in a row would result in relegation to a lower group and a loss of earned rewards credits. Contrarily, users in the lowest-uncertainty-and-lowest-reward group may have no consequences for not connecting to the grid within the time allotted but may only earn X points for connecting to the grid within the time allotted.

Customers may have the opportunity to opt-out of participation. When making the decision to opt-out, customers may be informed of a charge or penalty for opting out. Examples of charges or penalties may involve paying an alternate participant the lost incentive or being reassigned to a new grid-support group.

A customer's reliability may be measured by various variables that may be used to define grid-support groups. For example, suitable variables may include a ratio of the number of events to which a customer commits over the number of events to which the customer could commit; a ratio of the number of events to which a customer successfully plugs a vehicle into a grid within a time allotted over the number of events to which a customer commits; a comparison between a customer's commitment and other same-grid-support group customers' commitments; or many other definitions. Variables may be calculated as ratios, percentages, indices, numbers, rankings, or other mathematical abstractions. For example, a customer's reliability may be measured by a default-on-commitment parameter that describes the tendency for a user, either customer or vehicle, to be committed to connect to a grid within a certain duration then not meet that commitment.

A grid-support group may have a reliability measure instead of, or in addition to, a customer's individual reliability measure. In some embodiments, the grid-support group's overall reliability measure may affect the rewards and penalties applicable to the group.

Rewards may include points, money, credits for missing events, credits for defaulting without consequence, different charge or discharge rates, promotion to a different grid-support group, priority for future recharging, access to special promotions and events, cosmetic items for digital assets, maintenance discounts, or any other suitable incentive. Penalties may include loss of points or money, usage of credits for missing events, usage of credits for defaulting without consequence, different charge or discharge rates, relegation to a different grid-support group, exclusion, or loss of access to special promotions or events. Additional rewards or penalties may be applied to encourage participants to donate power to underserved or blackout areas. Also, sub-trading networks may be formed locally, such as within a neighborhood.

Customers may have some continued ability to manage their participation after self-assignment to a group. For example, in some embodiments, customers may have the ability to pause their commitment when their vehicle is being serviced or to auto-commit to all events when they leave the vehicle plugged in while they may be travelling out of town without their vehicle.

In some embodiments, during periods of sustained charge and discharge from a vehicle while participating in VPP, the vehicle's commitment may be set based on a combination of benefit and kWh required to participate. The charge and discharge may also be limited by the amount of power the vehicle would use or provide during the period outside of a sustained charge and discharge period. In some embodiments, a customer may limit the charge and discharge further than what would be used or provided otherwise. In some embodiments, the limits may be adjusted based on the health of the vehicle's battery, customer need, customer usage, and other external factors relevant to the ability for the EV to meet the needs of the grid and the customer's personal needs, such as a vehicle's state-of-charge or environmental factors like low ambient temperature. In some embodiments, a customer's ability to manage their participation may be restricted according to the flexibility of the needs of the grid.

In some embodiments, grid demand may be predicted by various algorithms and data. In some embodiments, participants' ability to meet demand are similarly predicted. In some embodiments, a set of potential offset candidates selected from outside a certain grid-support group. Those offset candidates may be requested to participate in a VPP event. Requests may be sent to offset candidates simultaneously to the certain grid-support group or following rejections or defaults from those from a grid-support group who cannot participate.

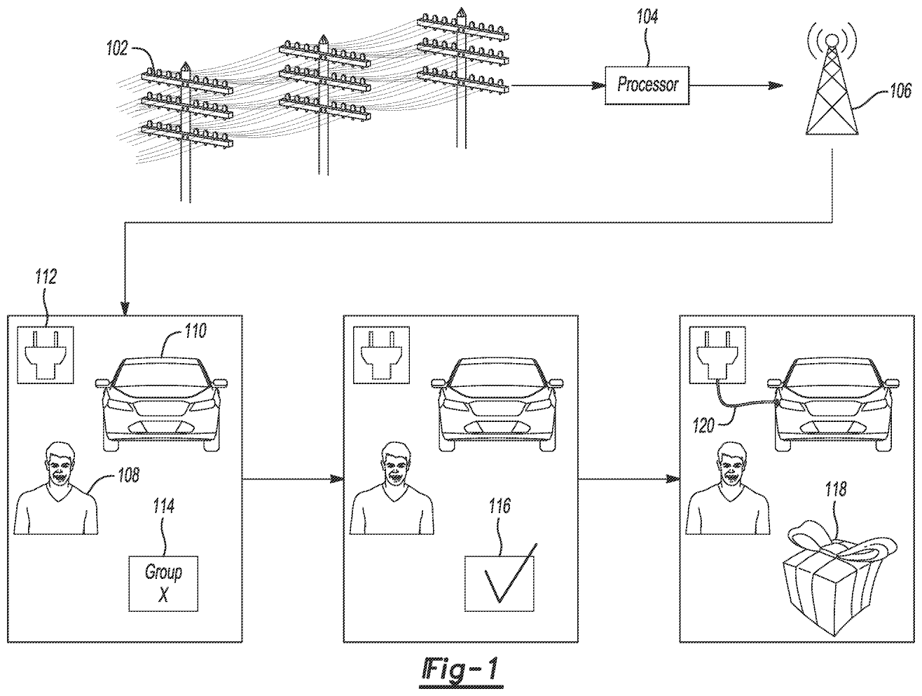

FIG. 1 is a flowchart of an example of VPP implementation. A VPP event may begin when a grid 102 experiences or is projected to experience an immediate or deferred demand. After receiving or sensing the demand of the grid 102, a processor 104 may send a request 106 to a customer 108 or to a vehicle 110 that is a member of a grid-support group 114. The customer 108 may provide an affirmative response 116 to the request 106, thereby signaling intent to connect the vehicle 110 to the grid 102 using a charger 112 within the timeframe set according to the demand. By the affirmative response 116 and the connection 120 established between the vehicle 110 and the grid 102 using the charger 112 within the timeframe set according to the demand, the customer 108 may have completed the requirements of the VPP event and may receive a reward 118.

Immediate and deferred may be defined based on the availability of local energy assets including EVs to connect to a grid within certain durations. For example, in some locales, immediate demand could require VPP participation within 30 minutes and deferred demand could require VPP participation within 2 hours. Note that the demand immediacy may be generalized to greater than two descriptors. For example, in some embodiments, a demand may be defined by bins of demand anticipated within 0 to 30 minutes, 30 to 60 minutes, . . . , (n-30) to n minutes. Bins could have smaller or larger sizes as desired.

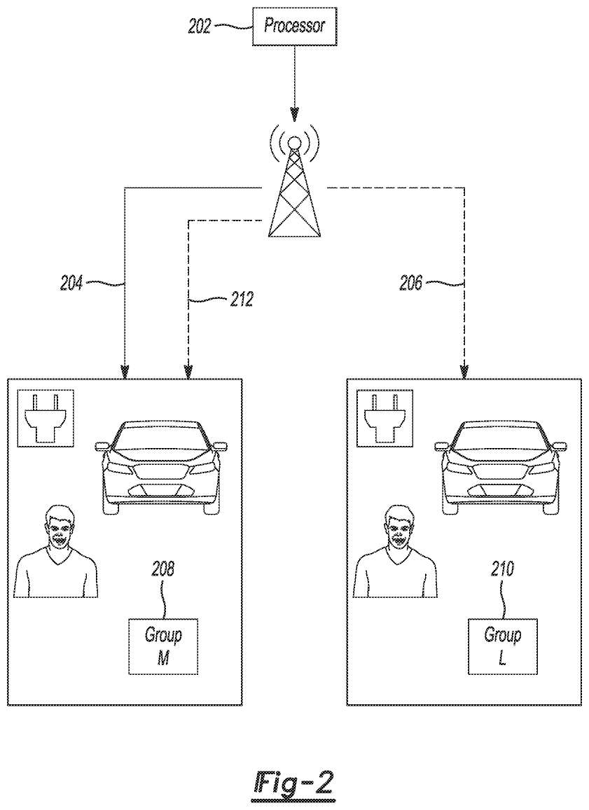

FIG. 2 is a flowchart of an example of sending selective requests based on a user's membership in a grid-support group. A processor 202 may send an exclusive request 204 to users of a first-grid support group 208. The exclusive request 204 is sent only to users of the first grid-support group whereby users of a second grid-support group 210 are excluded. At other times, the processor 202 may send non-exclusive requests 206, 212 to both users of the first grid-support group 208 and users of the second grid-support group 210. Note that the first grid-support group 208 may receive both the exclusive request 204 and the non-exclusive request 212, whereas the second grid-support group 210 may receive only the non-exclusive request 206.

The example of FIG. 2 may be generalized to more than two groups. Also, in FIG. 2, the set of recipients of the exclusive request 204 is a strict subset of the set of recipients of the non-exclusive requests 206, 212 which could be changed in some embodiments. For example, in some embodiments, the first non-exclusive request 212 could be deleted such that the exclusive request 204 would be sent to the first grid-support group 208 then the second non-exclusive request would be sent only to a second grid-support group. For example, in the embodiments mentioned or others, the first grid-support group 208 or its members may receive a penalty before or after the processor 202 sends the non-exclusive requests 206, 212. In any embodiments, alternative exclusivity models can be applied to other numbers of groups wherein the set of recipients of the exclusive request 204 is not a strict subset of the set of recipients of the non-exclusive requests 206, 212.

A processor may apply the principle of FIG. 2 to the process of FIG. 1. Further, the processor may send the exclusive request to a grid-support group that includes the most reliable users or users who have self-assigned into the highest-uncertainty-and-highest-reward group. For example, in some embodiments, a processor may send a request to a first grid-support group to meet immediate demand but may send requests to both the first grid-support group and a second grid-support group to meet deferred demand. In other embodiments, the processor may send a request to a first grid-support group to meet immediate demand and may send a request to a second grid-support group to meet deferred demand. In embodiments with more than two groups, requests may be sent to all groups to meet immediate demand, but groups may define different reward-and-penalty profiles that apply to members of the group. For example, in some embodiments, all groups receive a request to satisfy an immediate demand, but the highest-uncertainty-highest-reward group may earn 1000*X points for participation and pay 1000*X points for not participating whereas the lowest-uncertainty-and-lowest-reward group may earn X points for participation and pay no points for not participating. Groups with intermediate uncertainty and reward may face other reward and penalty balances.

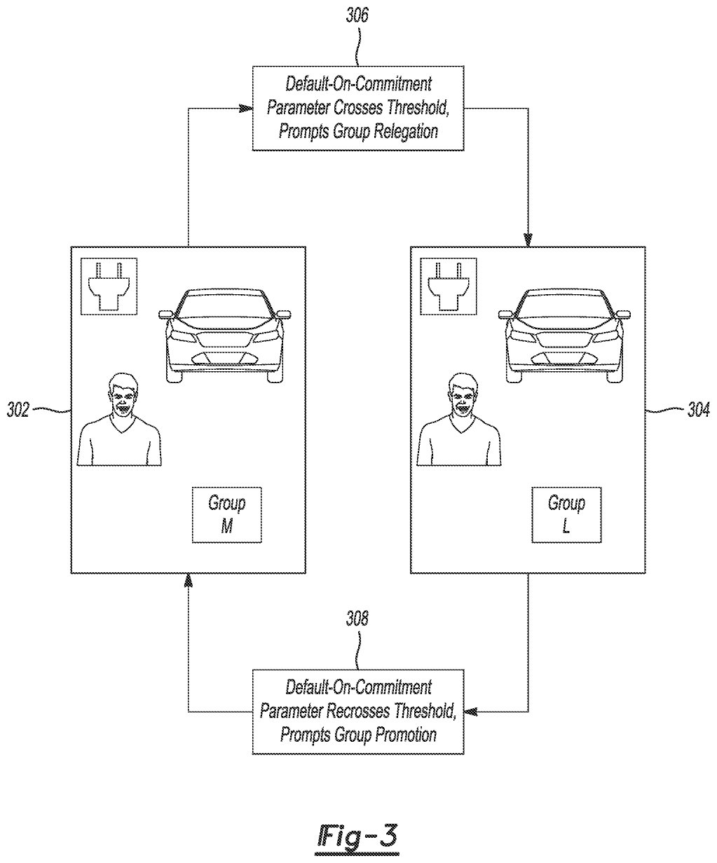

FIG. 3 is a flowchart of an example of reassigning a user between grid-support groups. A user, either customer or vehicle, assigned to a first grid-support group 302 may be relegated to a second grid-support group 304 when a predefined relegation event 306 occurs. Further, the user assigned to the second grid-support group 304 may be reassigned to the first grid-support group 302 when a predefined promotion event 308 occurs.

For example, consider a default-on-commitment parameter defined such that a high default-on-commitment parameter describes more frequent defaulting, i.e., lower user reliability. In this conception, the predefined relegation event 306 may occur when a user's default-on-commitment rises past a threshold. Accordingly, the user will be reassigned from the first grid-support group 302 to the second grid-support group 304. Conversely, a predefined promotion event 308 may occur when the user's default-on-commitment falls below the threshold. At such an event, the user will be reassigned from the second grid-support group 304 to the first grid-support group 302.

Alternatively, consider an exceeded-commitment parameter defined such that a high exceeded-commitment parameter describes more frequent compliance, i.e., higher user reliability. In this conception, the predefined promotion event 308 may occur, including reassignment from the second grid-support group 304 to the first grid-support group 302, when a user's exceeded-commitment parameter rises past a threshold. Rewards or compensation may thus be allocated to those that continue to provide more than the minimum commitment as they are not only reliable but also exceed expectations.

In some conceptions, the predefined relegation event 306 may have a different threshold for the default-on-commitment parameter than the threshold for the predefined promotion event 308. For example, consider a default-on-commitment parameter defined such that a low default-on-commitment parameter describes more frequent defaulting. In this example, the predefined relegation event 306 may occur when a default-on-commitment parameter of a user in group M falls below 10, but the predefined promotion event 308 may occur when a default-on-commitment parameter of a user in group L rises past 15.

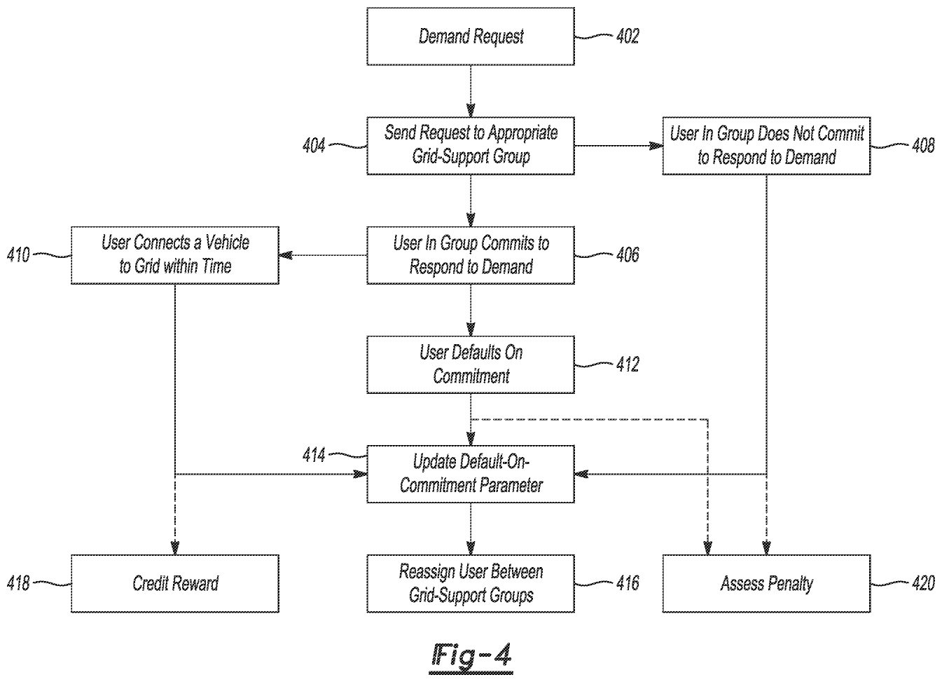

FIG. 4 is a block diagram of an example customer incentivization and management algorithm for VPP. The algorithm begins with a demand request step 402 wherein a demand request is generated when a demand for power from a grid will exceed a supply from the grid in the present or at some future time. The algorithm next includes a send request step 404 wherein a request for VPP participation is sent to members of a certain grid-support group chosen depending on the time duration until the demand will exceed the supply. Next, customers that receive the request either commit for a user to respond to demand in an affirmative response step 406 or do not commit for a user to respond to demand in a negative response step 408. The negative response step 408 may occur by a customer's non-response or by responding negatively to a request for a user's participation. Of those users committed to respond to demand in the affirmative response step 406, some may connect a vehicle to the grid within the timeframe allowed in a successful participation step 410 and some may default in a defaulting step 412. Sometime after any of the three user outcomes—the negative response step 408; the successful participation step 410; or the defaulting step 412—a default-on-commitment parameter of a user is updated to reflect the user outcome in an updating step 414. The updating step 414 may update the default-on-commitment parameter of a user after every user outcome, after every n-number of user outcomes, periodically with time (e.g., every week), or according to any other schedule. After the updating step 414, a user may need to be reassigned between grid-support groups in a reassignment step 416. Also, after some events or according to some schedules, users that passed through the successful participation step 410 may be credited a reward in a reward step 418, and users that passed through the defaulting step 412 or the negative response step 408 may receive a penalty in a penalty step 420.

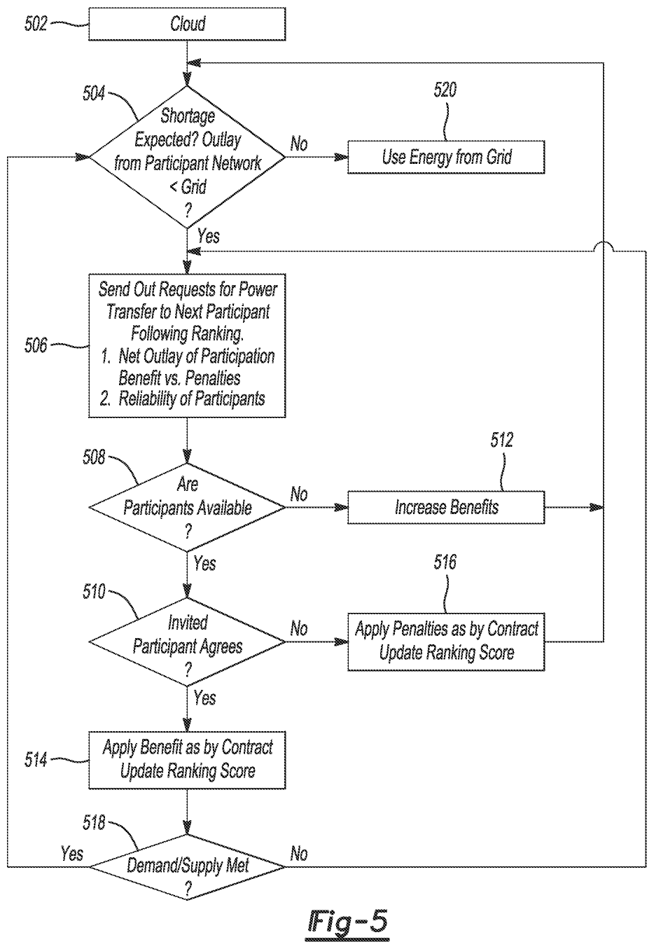

FIG. 5 is a block diagram of an example customer incentivization and management algorithm for VPP. This algorithm may be hosted in a cloud-based server 502. Note that this algorithm could be hosted on other devices such as a processor or non-cloud server architectures. A grid test step 504 asks whether a grid is expected to experience a shortage and whether the outlay of VPP is less than the outlay for power from a grid. If the grid test step 504 returns that a grid is not expected to experience a shortage or that the outlay for power from a grid is less than the outlay of VPP power, then the algorithm moves to a termination step 520 where no VPP is activated. In some embodiments, after the termination step 520 the algorithm returns to the grid test step 504 immediately, after some amount of time, or after some other event. If the grid test step 504 returns both the grid is expected to experience a shortage, and the outlay for power from VPP is less than the outlay for power from the grid, then the algorithm moves to a notification step 506.

In the notification step 506, the cloud-based server 502 (or processor or other non-cloud server architectures) sends a request for VPP participation to a next participant in a ranking system. Participant may describe grid-support groups or even individual users. The ranking system may be created by arranging users according to increasing or decreasing default-on-commitment parameters, arranging groups according to increasing or decreasing average default-on-commitment parameters, or other orderings of a user's participation in VPP.

After the notification step 506, responses from users are weighed against an aggregate test step 508. The aggregate test step 508 weighs the ability for users to respond to the need of the grid within the time required. If the aggregate test step 508 returns that users cannot respond to the need of the grid within the time required, the algorithm moves to an increase reward step 512 then returns to the grid test step 504. Alternatively, if the aggregate test step 508 returns that users can respond to the need of the grid within the time required, the algorithm moves to a user participation test step 510. In the increase reward step 512, the reward for participation may be increased incrementally, proportionally to number of available users, proportionally to need of the grid, or according to some other design.

In the user participation test step 510, the user may agree or refuse to participate in VPP. If the user participation test step 510 returns that a user agrees to participate, then the algorithm moves to a reward step 514. If the user participation test step 510 returns that a user refuses to participate, the algorithm moves to a penalty step 516. The reward step 514 may include sending rewards or credits to a user or user account. The reward step 514 may include updating a ranking, reliability measure, or default-on-commitment parameter of a user. The penalty step 516 may include deducting rewards or credits or sending penalty tokens to a user or user account. The penalty step 516 may include updating a ranking, reliability measure, or default-on-commitment parameter of a user.

Note that in some embodiments, an additional step may be placed between the user participation test step 510 and the reward step 514 that tests whether users successfully connect a vehicle to a grid within a certain time. In embodiments that include this additional step, a user that successfully connects within a certain time may progress to the reward step 514 and a user that does not successfully connect within a certain time may progress to the penalty step 516 or possibly a different penalty step (unpictured).

After the reward step 514, the algorithm moves to a VPP adequacy test step 518 that asks whether the VPP-provided supply has met the demand of the grid. If the VPP adequacy test step 518 returns that the demand of the grid is met, then the algorithm returns to the grid test step 504. If the VPP adequacy test step 518 returns that the demand of the grid is not met, then the algorithm returns to the notification step 506. After the penalty step 516, the algorithm returns to the grid test step 504. In some embodiments, the penalty step 516 is followed by returning to other steps, such as the VPP adequacy test step 518, the notification step 506, the aggregate test step 508, or the increase reward step 512.

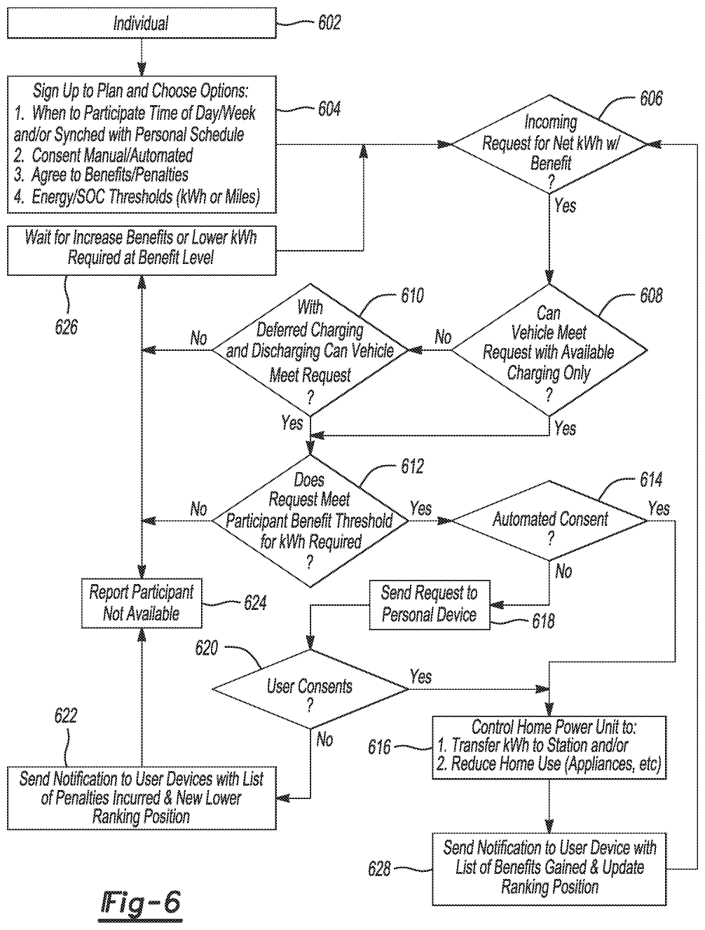

FIG. 6 is a block diagram of an example customer incentivization and management algorithm for VPP. This algorithm may describe a participation of a user 602 in VPP. The user 602 may be a customer or a vehicle. For example, consider one customer that has two vehicles eligible for VPP. Some embodiments may track VPP participation of the customer over both customer's vehicles. Alternatively, some embodiments may track VPP participation of each of the customer's vehicles individually. Other users may not have two vehicles eligible for VPP but may have multiple energy assets available for VPP. Similarly, some embodiments may assign a default-on-commitment parameter to a customer, to sets of energy assets that belong to a predefined class, or to each of the customer's devices individually. The user 602 must first face an enrollment step 604 to access VPP participation opportunities. In the enrollment step 604, customers may be able to schedule participation, set-up automatic consent to VPP events, set limits on benefits or penalties required to be met for participation, or set limits on a state of charge or total energy of a battery in a vehicle to prioritize transportation needs or reduce wear-and-tear. After the enrollment step 604, the user may be requested to participate in future VPP opportunities. In FIG. 6, one such request for VPP participation is shown in the algorithm as a requesting step 606.

In the requesting step 606, a customer may receive a notice of how much power (in, e.g., kWh) is requested and how much benefit/reward is offered. The algorithm moves to an immediate delivery test step 608. In the immediate delivery test step 608, the algorithm returns whether a user can meet the power requested in the requesting step 606 immediately. If the immediate delivery test step 608 returns that a user can meet the request of the requesting step 606 with available charging only, then the algorithm proceeds to a benefit test step 610. If the immediate delivery test step 608 returns that a user cannot meet the request of the requesting step 606 with available charging only, then the algorithm proceeds to a deferred delivery test step 610.

The deferred delivery test step 610 tests whether a user can meet the power requested in the requesting step 606 by deferred charging and discharging. If the deferred delivery test step 610 returns that a user can meet the request of the requesting step 606 with deferred charging and discharging, then the algorithm proceeds to the benefit test step 612. If the deferred delivery test step 610 returns that a user cannot meet the request of the requesting step 606 with deferred charging and discharging, then the algorithm proceeds to a charge-benefit adjustment step 626 and a reporting step 624.

The benefit test step 612 determines whether a benefit and power required meet a user's settings. If the benefit test step 612 returns that a request's benefit meets the user's minimum benefit threshold at the amount of power requested, then the algorithm proceeds to an automated consent test step 614. If the benefit test step 612 returns that a request's benefit does not meet the user's minimum benefit threshold at the amount of power requested, then the algorithm proceeds to the charge-benefit adjustment step 626 and the reporting step 624. In the charge-benefit adjustment step 626, the user waits for benefits to increase, or the amount of power requested to decrease so that the benefits and power requested meet the user's settings. If the benefits or power requested are adjusted to meet the user's settings, the algorithm returns to the requesting step 606. In the reporting step 624, the user is marked as currently unavailable for the current VPP opportunity.

The automated consent test step 614 tests whether a customer has selected, during enrollment or afterward, to automatically consent for a user to participate in VPP opportunities that meet the power request and benefit settings associated to the user. If the automated consent test step 614 returns that the user has selected to automatically consent, the algorithm moves to a control step 616. If the automated consent test step 614 returns that the user has not selected to automatically consent, the algorithm moves to a notification step 618. In the notification step 618, the customer is offered a choice for a user to participate in a VPP event. The customer may be offered a choice by any communication modality—notification on a digital display of a vehicle or other energy asset, notification pushed from an app on a user's phone, tablet, computer, or other personal device, notification by text, phone call, or email, or any other method.

A manual consent test step 620 follows the notification step 618. The manual consent test step 620 tests whether the customer has manually consented for a user to participate in the current VPP opportunity. If the manual consent test step 620 returns that a customer has consented for a user to participate in the current VPP opportunity, the algorithm proceeds to the control step 616. If the manual consent test step 620 returns that a customer has not consented for a user to participate in the current VPP opportunity, the algorithm proceeds to a penalty step 622. The penalty step 622 may include sending a notification to a customer through any of the modalities previously mentioned to describe a list of penalties incurred and an updated ranking that reflects a reduced reliability of a user. In other embodiments, the penalty step 622 may not send a notification, but may assess penalties and update a user's ranking anyway. In other embodiments, a customer may select whether to receive penalty notifications for every opportunity, never, or at some other time-or event-based interval. Also, note that FIG. 6 mentions “lower ranking” position. In some embodiments, a lower ranking may reflect a more reliable user that belongs to a higher-uncertainty-and-higher-reward grid-support group such that “higher ranking” would be more appropriately drawn. After the penalty step 622, the algorithm proceeds to the reporting step 624.

In the control step 616, the applicable energy asset may provide power to the grid directly or may be adjusted to draw less power from the grid than it would without participation in the current VPP opportunity. After the control step 616, the algorithm moves to a reward step 628. The reward step 628 may include sending a notification to a customer through any of the modalities previously mentioned to describe a list of rewards received and an updated ranking that reflects a reliability of a user. In other embodiments, the reward step 628 may not send a notification, but may provide rewards and update a user's ranking anyway. In other embodiments, a customer may select whether to receive reward notifications for every opportunity, never, or at some other time- or event-based interval. Note that ranking systems may be designed such that both higher and lower rankings could denote more reliability. Following the reward step 628, the algorithm returns to the requesting step 606, likely applicable to a future VPP opportunity.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials. The terms “processor” and “processors,” for example, can be used interchangeably herein as the functionality of a processor or controller can be distributed across several processors/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A dynamic power management system comprising:
a processor programmed to,
responsive to immediate demand to support a grid, send requests to a first grid-support group to connect to the grid within a first duration of time such that at least some vehicles associated with the first grid-support group connect to the grid within the first duration of time;
responsive to deferred demand to support the grid, send requests to a second grid-support group to connect to the grid within a second duration of time longer than the first duration of time such that at least some vehicles associated with the second grid-support group connect to the grid within the second duration of time; and
responsive to a default-on-commitment parameter of a user, representing an index at which the user is committed to connect a vehicle to the grid and subsequently defaults on that commitment, crossing a predefined threshold, reassign the user from the first grid-support group to the second grid-support group such that the user receives the requests to the second grid-support group but not the requests to the first grid-support group.

2. The dynamic power management system of claim 1, wherein the processor is further programmed to,
responsive to the default-on-commitment parameter recrossing the predefined threshold, reassigning the user from the second grid-support group to the first grid-support group such that the user receives the requests to the first grid-support group.

3. The dynamic power management system of claim 2, wherein the processor is further programmed to,
responsive to the default-on-commitment parameter recrossing the predefined threshold, reassigning the user from the second grid-support group to the first grid-support group such that the user receives the requests to the first grid-support group but not the requests to the second grid-support group.

4. The dynamic power management system of claim 1, wherein the processor is further programmed to,
responsive to the user fulfilling a commitment to connect to the grid, credit a reward to the user.

5. The dynamic power management system of claim 4, wherein the reward is different depending on whether the user is assigned to the first grid-support group or the second grid-support group.

6. The dynamic power management system of claim 1, wherein the processor is further programmed to,
responsive to the user defaulting on a commitment to connect to the grid, assess a penalty to the user.

7. The dynamic power management system of claim 6, wherein the penalty is different depending on whether the user is assigned to the first grid-support group or the second grid-support group.

8. The dynamic power management system of claim 1, wherein the user is a vehicle or a person.

9. The dynamic power management system of claim 1, wherein the processor is further programmed to, responsive to an exceeded-commitment parameter of the user crossing another predefined threshold, reassign the user from the second grid-support group to the first grid-support-group.

10. A method for dynamic power management comprising:
responsive to immediate demand to support the grid, sending requests to a first grid-support group to connect to the grid within a first duration of time such that at least some vehicles associated with the first grid-support group connect to the grid within the first duration of time;
responsive to deferred demand to support the grid, sending requests to a second grid-support group to connect to the grid within a second duration of time longer than the first duration of time such that at least some vehicles associated with the second grid-support group connect to the grid within the second duration of time; and
responsive to a default-on-commitment parameter of the user, representing an index at which the user is committed to connect a vehicle to the grid and subsequently defaults on that commitment, crossing a predefined threshold, reassigning the user from the first grid-support group to the second grid-support group such that the user receives the requests to the second grid-support group but not the requests to the first grid-support group.

11. The method for dynamic power management of claim 10 further comprising responsive to the default-on-commitment parameter recrossing the predefined threshold, reassigning the user from the second grid-support group to the first grid-support group such that the user receives the requests to the first grid-support group.

12. The method for dynamic power management of claim 11 further comprising responsive to the default-on-commitment parameter recrossing the predefined threshold, reassigning the user from the second grid-support group to the first grid-support group such that the user receives the requests to the first grid-support group but not the requests to the second grid-support group.

13. The method for dynamic power management of claim 10 further comprising responsive to the user fulfilling a commitment to connect to the grid, crediting a reward to the user.

14. The method for dynamic power management of claim 13, wherein the reward is different depending on whether the user is assigned to the first grid-support group or the second grid-support group.

15. The method for dynamic power management of claim 10 wherein the user is a vehicle or a person.

16. The method for dynamic power management of claim 10 further comprising, responsive to an exceeded-commitment parameter of the user crossing another predefined threshold, reassigning the user from the second grid-support group to the first grid-support-group.

17. A dynamic power management system comprising:
a processor programmed to,
responsive to immediate demand to support a grid, send requests to a first grid-support group to connect to the grid within a first duration of time such that at least some vehicles of the first grid-support group connect to the grid within the first duration of time and credit rewards to the at least some vehicles of the first grid-support group; and
responsive to deferred demand to support the grid, send requests to both the first grid-support group and a second grid-support group to connect to the grid within a second duration of time longer than the first duration of time such that at least some vehicles of the first grid-support group or the second grid-support group connect to the grid within the second duration of time and credit rewards to the at least some vehicles of the first grid-support group or the second grid-support group.

18. The dynamic power management system of claim 17, wherein the processor is further programed to responsive to a default-on-commitment parameter of a user, representing an index at which the user is committed to connect a vehicle to the grid and subsequently defaults on that commitment, crossing a predefined threshold, reassign the user from the first grid-support group to the second grid-support group such that the user receives the requests to the second grid-support group but not the requests to the first grid-support group.

19. The dynamic power management system of claim 18, wherein the processor is further programmed to, responsive to the user fulfilling a commitment to connect to the grid, credit a reward to the user.

20. The dynamic power management system of claim 18, wherein the processor is further programmed to, responsive to the user defaulting on a commitment to connect to the grid, assess a penalty to the user.
